(19) United States
(12) Patent Application Publication
(10) Pub. No.: US 2017/0139826 A1
(43) Pub. Date: May 18, 2017

(54) MEMORY SYSTEM, MEMORY CONTROL DEVICE, AND MEMORY CONTROL METHOD

(71) Applicant: KABUSHIKI KAISHA TOSHIBA, Tokyo (JP)

(72) Inventor: Yutaka SUGIMORI, Chigasaki Kanagawa (JP)

(21) Appl. No.: 15/243,632

(22) Filed: Aug. 22, 2016

Related U.S. Application Data
(60) Provisional application No. 62/256,556, filed on Nov. 17, 2015.

(51) Int. Cl. G06F 12/02; G06F 3/06; G06F 12/10

(52) U.S. Cl. CPC G06F 12/0253; G06F 12/0246; G06F 12/10; G06F 3/0604; G06F 3/064; G06F 3/0679

(57) ABSTRACT

A memory system includes a non-volatile memory including a plurality of memory blocks, a memory block being a unit of data erasing, and a memory controller configured to control data writing into the non-volatile memory, data erasing from the non-volatile memory, and garbage collection of the non-volatile memory. When the garbage collection is carried out with respect to a target memory block, the memory controller selects a memory block to which valid data stored in the target memory block are to be transferred based on a value indicating access frequency to a logical address range mapped to the valid data.

### CROSS-REFERENCE TO RELATED APPLICATIONS

This application is based upon and claims the benefit of priority from U.S. Provisional Patent Application No. 62/256,556, filed on Nov. 17, 2015, the entire contents of which are incorporated herein by reference.

### FIELD

Embodiments described herein relate generally to a memory system, a memory control device, and a memory control method.

### BACKGROUND

A memory system of one type that includes a non-volatile memory carries out garbage collection, i.e., transfers data from one or more of memory blocks of the non-volatile memory (target memory blocks) to one or more other memory blocks and erases or invalidates data stored in the target memory blocks. During garbage collection, typically, valid data stored in the target memory blocks are selectively transferred. As a ratio of valid data to all data (both valid and invalid data) stored in the target memory blocks becomes larger, it takes more time to complete the garbage collection because of a larger amount of data needs to be transferred. As a result, the memory system may not be able to perform other operations until garbage collection completes and latency of operations may increase.

### BRIEF DESCRIPTION OF THE DRAWINGS

FIG. 1 illustrates a configuration of a memory system and a memory control device thereof according to a first embodiment.

FIG. 2 illustrates an example of a translation table stored in the memory control device.

FIG. 3 schematically illustrates an example of statuses of blocks of a non-volatile memory in the memory system.

FIG. 4 illustrates an example of a block management table stored in the memory control device.

FIG. 5 illustrates an example of an access frequency management table and a flow of an update thereof.

FIG. 6 schematically illustrates status of blocks in the non-volatile memory.

FIG. 7 is a flowchart illustrating a flow of a process executed by a garbage collection (GC) manager in the memory control device.

FIG. 8 is a flowchart illustrating a flow of a process executed by the memory system according to the first embodiment, in response to a write command.

FIG. 9 illustrates simulation results of valid data ratios when the memory system according to the first embodiment is operated and when a memory system according to a comparative example is operated.

FIG. 10 is a flowchart illustrating a flow of a process executed by a memory system according to a second embodiment, in response to a write command.

FIG. 11 illustrates an example of an access frequency management table according to the second embodiment.

FIG. 12 illustrates a memory system and a memory control device therein according to a third embodiment.

FIG. 13 illustrates a memory system according to a first modification example.

FIG. 14 illustrates a memory system according to a second modification example.

### DETAILED DESCRIPTION

A memory system includes a non-volatile memory including a plurality of memory blocks, a memory block being a unit of data erasing, and a memory controller configured to control data writing into the non-volatile memory, data erasing from the non-volatile memory, and garbage collection of the non-volatile memory. When the garbage collection is carried out with respect to a target memory block, the memory controller selects a memory block to which valid data stored in the target memory block are to be transferred based on a value indicating access frequency to a logical address range mapped to the valid data.

Below, a memory system, a memory control device, and a memory control method of a plurality of embodiments are described with reference to the drawings.

### First Embodiment

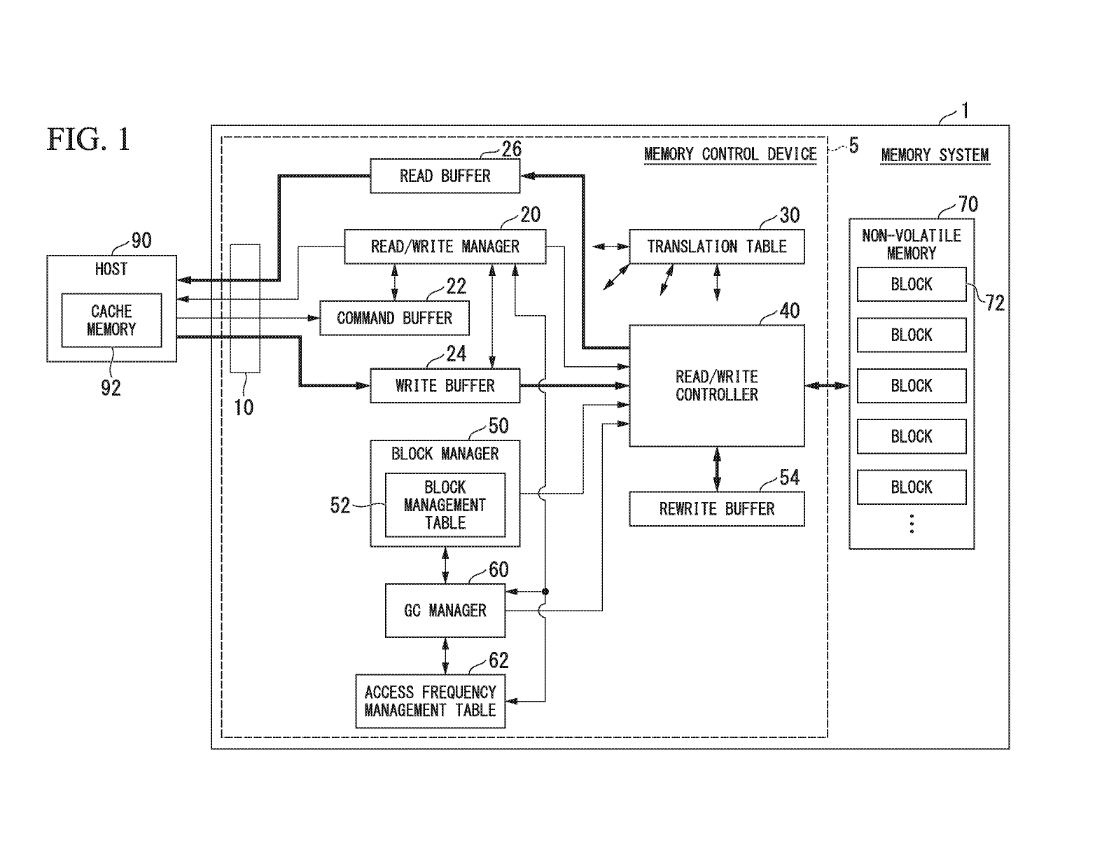

FIG. 1 illustrates a configuration of a memory system 1 and a memory control device 5 thereof according to a first embodiment. The memory system 1 includes a host interface 10, a read/write manager 20, a command buffer 22, a write buffer 24, a read buffer 26, a translation table 30, a read/write controller 40, a block manager 50, block management table 52, a rewrite buffer 54, a garbage collection manager (a GC manager) 60, an access frequency management table (overwrite frequency management table) 62, and a non-volatile memory 70. However, the configuration of the memory system 1 is not limited thereto. In FIG. 1, elements of the memory system 1 except for the non-volatile memory 70 corresponds to the memory control device 5.

The host interface 10 may be an SATA (Serial ATA) interface or an SAS (Serial Attached SCSI) interface, but not limited thereto. The host interface 10 is connected to a host 90 by a connector and receives various commands from the host 90. The commands may be autonomously sent by the host 90, or may be sent from the host 90 in response to a request for a command transmitted (making a command fetch) to the host 90 from the memory system 1.

The host (client) 90 is an information processing device such as a personal computer, a server device, etc. The host 90 may be an information processing device used by a user of the memory system 1, or a device which transmits various commands to the memory system 1 based on commands, etc., that are received from a different device. Moreover, the host 90 may generate various commands and transmit the generated commands to the memory system 1, based on results of internal information processing.

The host 90 includes an LBA (logical block address), which is a logical address, in a command to read or write data and transmits the command including the LBA to the host interface 10. The memory system 1 may be accommodated in a housing of the host 90, or may be provided independently from the host 90.

The read/write manager 20, the read/write controller 40, the block manager 50, and the GC manager 60 may be implemented by hardware such as LSI (large scale integration), an ASIC (application specific integrated circuit), a PLC (programmable logic controller), etc., and the individual elements may include a circuit configuration, etc., for performing the corresponding functions. Alternatively, some or all of the read/write manager 20, the read/write controller 40, the block manager 50, and the GC manager 60 may be implemented by a processor such as a CPU (central processing unit) executing programs.

The command buffer 22, the write buffer 24, the read buffer 26, the translation table 30, the block management table 52, and the access frequency management table 62 are set in a volatile memory (not shown), which is included in the memory system 1. As the volatile memory, various RAMs such as a DRAM (dynamic random access memory), etc., may be used. Moreover, the translation table 30, the block management table 52, and the access frequency management table 62 may be saved in the non-volatile memory 70 when power of the memory system 1 is turned off, and read from the non-volatile memory 70 and loaded in the volatile memory the next time power is turned on.

The read/write manager 20 instructs the read/write controller 40 to write data into the non-volatile memory 70 based on a write command received from the host 90 or read data from the non-volatile memory 70 based on a read command received from the host 90.

The commands received from the host 90 are stored in the command buffer 22. If the write command is stored in the command buffer 22, the read/write manager 20 secures a write region in the write buffer 24 and transmits a data transmission request to the host 90. In response thereto, the host 90 transmits data of which writing is requested (write data) to the memory system 1. The write data received from the host 90 by the memory system 1 are stored in the write buffer 24. The read/write manager 20 instructs the read/write controller 40 to write the data stored in the write buffer 24 to a physical address of the non-volatile memory 70 that corresponds to the LBA in the write command. The memory system 1 may receive the write data along with a command rather than acquire the write data in the manner described above.

On the other hand, when the read command is stored in the command buffer 22, the read/write manager 20 reads data from the physical address of the non-volatile memory 70 that corresponds to the LBA in the read command and stores the read data in the read buffer 26.

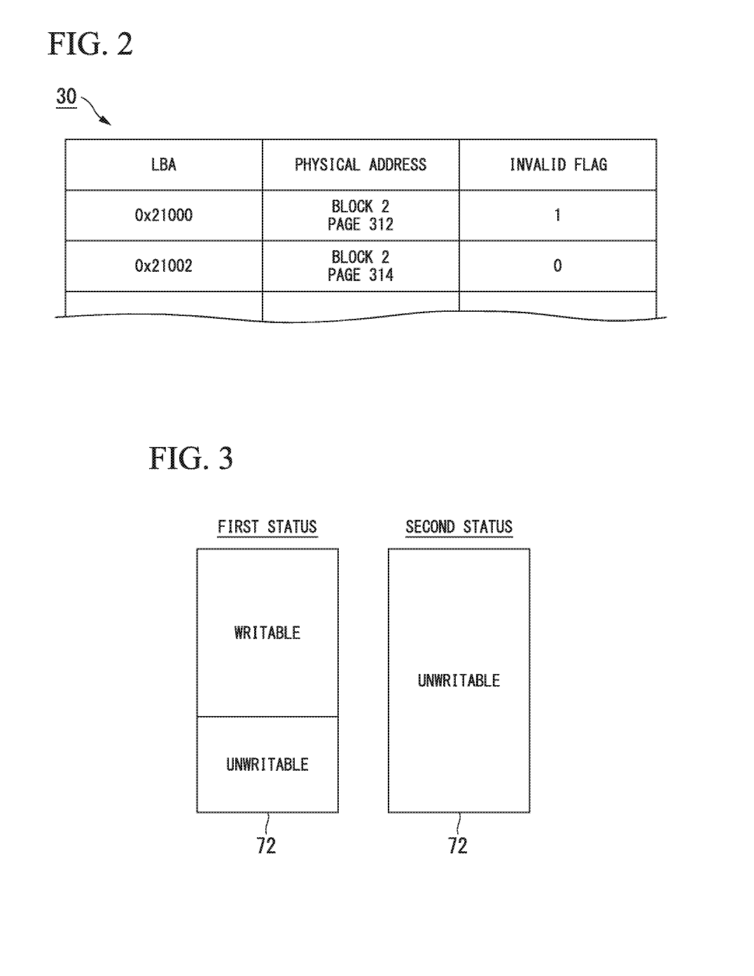

FIG. 2 illustrates an example of the translation table 30. The translation table 30 is a table for translating between a logical address such as the LBA and a physical address of the non-volatile memory 70. The LBA is a logical address, which is a sequential number starting from 0 that is assigned to each sector of the non-volatile memory 70, which has the size of 512B, for example. While the physical address may be expressed with a block number and a page number, it is not limited thereto. In the translation table 30, the LBA and an invalid flag, which indicates that the corresponding data are invalid, may be associated with the physical address. Validity of data will be described below.

If the correspondence between the physical address and the LBA is changed by writing data into the non-volatile memory 70, the translation table 30 is updated by the read/write controller 40. The memory system 1 may include one translation table 30 or may redundantly include a plurality of translation tables 30.

The invalid flag is flag information (for example, 1) indicating invalidity when data associated with the same LBA are written into a different physical address. For example, if a write command which designates an LBA same as an LBA designated in a previous write command, the invalid flag is set to 1 for the storage location in which data were written in accordance with the previous write command. Moreover, if data are moved within the non-volatile memory 70 by the below-described GC manager 60, etc., the invalid flag is set to 1 for the storage location from which the data have been moved. When a plurality of invalid flags is present in the translation table 30 for different LBA entries, the read/write manager 20 instructs the read/write controller 40 to read data from a physical address corresponding to the LBA for which the invalid flag is not set to 1 (a physical address at which valid data are stored) and store the read data in the read buffer 26. Such a selection process may be performed by the read/write controller 40.

Alternatively, the translation table 30 may not include an invalid flag for each entry, and an entry of an LBA corresponding to invalid data may be deleted from the translation table 30.

Furthermore, the host 90 may append arbitrary key information instead of the LBA to a command and transmit the command along with the key information to the memory system 1. In this case, the memory system 1 performs a process using a translation table which translates between key information and the physical address instead of between the LBA and the physical address. Alternatively, a translation table which translates between information obtained by hashing the key information and the physical address may be used.

The read/write controller 40 includes an interface circuit, which is an interface with the non-volatile memory 70, an error correction circuit, a DMA controller, etc. (each of which are not shown). The read/write controller 40 writes data stored in the write buffer 24 into the non-volatile memory 70 or reads data stored in the non-volatile memory 70 and stores the read data in the read buffer 26.

The block manager 50 includes the block management table 52. Here, while the non-volatile memory 70 may be a NAND memory, it is not limited thereto. The non-volatile memory 70 includes a plurality of blocks 72 (first regions), each of which is a unit for erasing data. The block manager 50 manages the status of each block 72. Writing of data in the non-volatile memory 70 is performed in a unit of a cluster. The size of the cluster may be the same as a size of a page in the NAND memory, or it may be different therefrom.

FIG. 3 schematically illustrates an example of different statuses of a block 72. The block 72 may be in a first status in which a writable region is present and a second status in which no writable region is present. The block 72 may be in the first status immediately after data have been erased. In other words, data may be written into all of the regions of some blocks in the first status, more specifically a free block status. Moreover, the block 72 may be in the second status not only when no writable region is present, but also when a capacity of the writable region is less than a certain level.

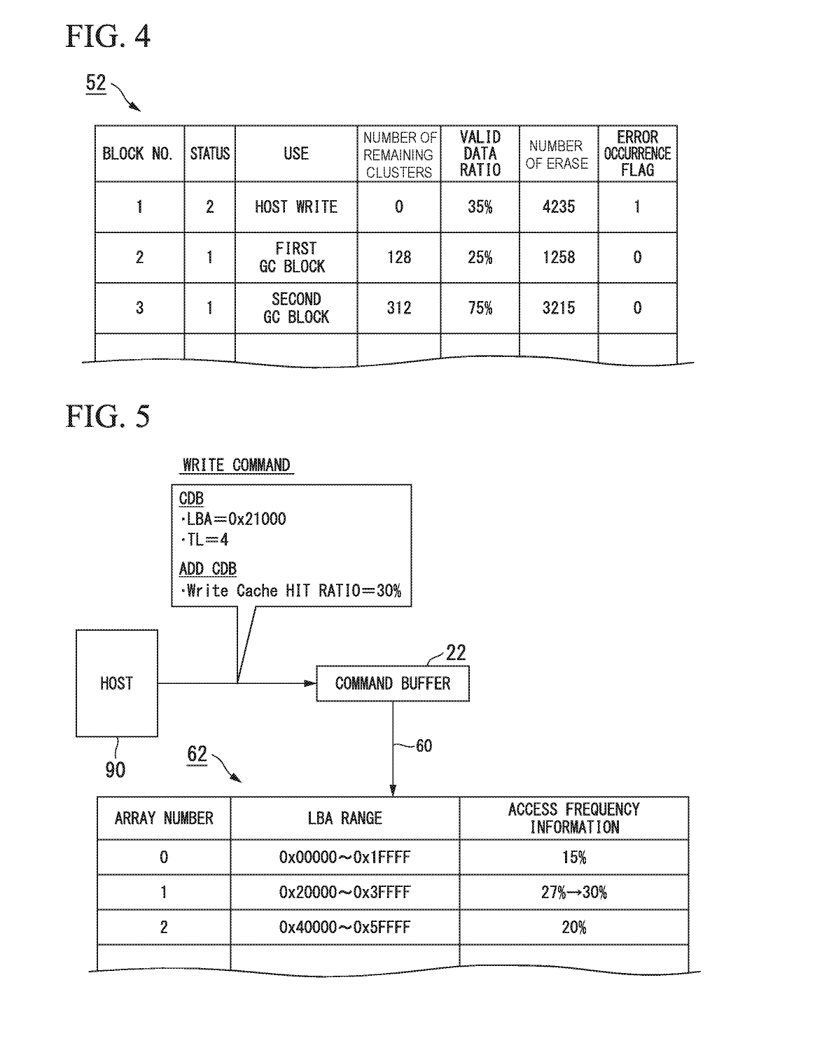

FIG. 4 illustrates an example of the block management table 52. The block management table 52 may include, in each entry, items such as “status,” which indicates either the first or the second status in FIG. 3, “use,” which indicates whether the block 72 is a block for host write, a first GC (garbage collection) block, or a second GC block, “the number of remaining clusters,” which indicates the number of writable clusters in the block, “valid data ratio,” which indicates the percentage of valid data in the block; “the number of erase times,” which indicates the number of times erasure has been performed for the block, and “an error occurrence flag,” which indicates that an error has occurred at the time of reading data from the block, in association with a “block No.” of the block. The block management table 52 may further include, in each entry, information indicating whether the block is a free block or an active block (not the free block), instead of (or in addition to) the “status.”

Each item in the block management table 52 may be updated by the block manager 50 based on information reported from the elements of the memory system 1. The block manager 50 may perform refresh and wear leveling on the non-volatile memory 70.

The refresh is a process to rewrite data stored in a block 72 (target block) into a different block. More specifically, the refresh is a process to rewrite all data (valid and invalid), all valid data, or all valid data and part of invalid data that are stored in the target block into the different block. The block manager 50 performs the refresh on a block 72 when an entry of the block management table 52 corresponding to the target block indicates that an error has occurred by “the error occurrence flag”, for example. If an error correction process is performed by the read/write controller 40, “the error occurrence flag” is updated by the block manager 50 upon receiving a report from the read/write controller 40. If the refresh is performed, the error occurrence flag of the corresponding block 72 is cleared (changed back to 0, for example).

The wear leveling is a process of leveling the number of rewrite times, the number of write times, the number of erase times, or an elapsed time from erasure to be equal among the blocks 72 or among memory cells. The wear leveling may be executed as a process of selecting a write destination when a write command is received and as a process of relocating data independently of the write command.

Returning to FIG. 1, the rewrite buffer 54 stores data that are read from the non-volatile memory 70 and to be written again into the non-volatile memory 70, when the refresh, the wear leveling, or the below-described garbage collection is executed.

The GC manager 60 moves valid data stored in at least one block 72 (target block) to a different block and erases or invalidates data stored in the target block, and this process is called as garbage collection.

The valid data refer to data stored in an LBA for which invalid flag is not set to 1 in the translation table 30. On the other hand, the invalid data may be data stored in an LBA for which invalid flag is set to 1 in the translation table 30.

Moreover, when an entry of an LBA corresponding to invalid data is deleted from the translation table 30, the valid data may be defined as data which are associated with the LBA in the translation table 30. On the other hand, the invalid data may be defined as data which are not associated with the LBA in the translation table 30.

In either case, the valid data may include at least data that are readable from the non-volatile memory 70 to the host 90 in response to a read command from the host 90 and further include control information, etc., used within the memory system 1.

The GC manager 60 determines whether to perform garbage collection when the memory system 1 receives a write command from the host 90, the timing to perform garbage collection is not limited thereto. The GC manager 60 may execute garbage collection regardless of commands received from the host 90.

Moreover, when performing garbage collection, the GC manager 60 determines a block 72 to which data are to be moved (destination block), by referring to an access frequency management table 62, which indicates access frequency (more specifically, overwrite frequency) with respect to each LBA range.

FIG. 5 illustrates the access frequency management table 62 and a flow to update the access frequency management table 62. The access frequency management table 62 is a table that indicates, in each entry, access frequency information (more specifically, overwrite frequency value) with respect to an LBA range of a predetermined width. The access frequency information indicates access frequency for data of LBA included in the LBA range.

The access frequency information according to the first embodiment may be a write cache hit ratio in a cache memory 92 of the host 90. The write cache hit ratio is calculated for each LBA. The write cache hit ratio is obtained by dividing the number of times data corresponding to a write command changed to new data without transmitting the write command to the memory system 1 as the data to be written are updated to the new data before the write command is transmitted to the memory system 1 by the number of times the host 90 operates to write data into the LBA. Moreover, when a file server, etc., including a cache memory is present between the host 90 and the memory system 1, the access frequency information may be a write cache hit ratio in the file server, etc. Furthermore, instead of the write cache hit ratio, both the write cache hit ratio and a read cache hit ratio may be received from the host 90, etc., as the access frequency information.

As shown in FIG. 5, the LBA and “TL (unit: kB)” indicating the total data length are stored in a frame of CDB in the write command transmitted by the host 90. Moreover, the write cache ratio may be included in a frame of ADD CDB item in the write command. The GC manager 60 acquires the write cache hit ratio from the write command stored in the command buffer 22 and updates the access frequency management table 62.

Upon acquiring the write cache hit ratio from the write command, the GC manager 60 searches an entry in the access frequency management table 62 that corresponds to the LBA included in the write command and updates the access frequency information of the entry. In FIG. 5, as information that the write cache hit ratio corresponding to the LBA “0x21000” is 30% is acquired, the GC manager 60 modifies access frequency information corresponding to the LBA range (“0x20000”-“0x3FFFF”), in which the LBA “0x21000” is included.

Here, the LBA range included in the write command may be smaller than the LBA range set in each entry of the access frequency management table 62. In this case, the GC manager 60 may adjust a degree of modifying the access frequency information based on a width of the LBA range in the write command relative to the width of LBA range set in each entry. For example, in FIG. 5, when the width of the LBA range in the write command correspond to a third of the LBA range set in the corresponding entry, the GC manager 60 may modify the access frequency information to 28%, which is a weighted average value of 30% and 27%.

The access frequency information such as the write cache hit ratio, etc., may be included in different data (a command and other data) which are transmitted to the memory system 1 together with a write command and acquired by the memory system 1 from the different data. “Together with” may mean that the access frequency information may be transmitted each time the write command is transmitted (i.e., one-on-one relationship), or that data including the access frequency information are transmitted once in a given number of times a command is transmitted.

As described above, when performing garbage collection, the GC manager 60 determines a block 72 to which data are to be moved (destination block) by referring to the access frequency management table 62 which indicates access frequency to the corresponding LBA. As destination blocks, the GC manager 60 prepares at least one each of the first GC block and the second GC block in the first status block 72.

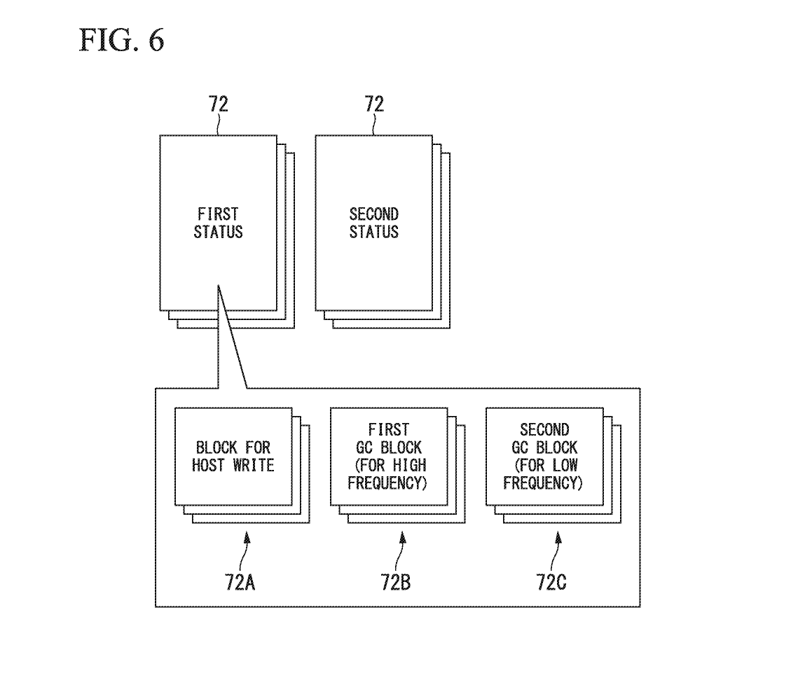

FIG. 6 illustrates detailed statuses of the blocks 72 of the non-volatile memory 70. The blocks 72 include one or more blocks in the first status and one or more blocks in the second status. The blocks in the first status may include a block for host write 72A, a first GC block 72B, and a second GC block 72C. The first GC block 72B can be the destination block for garbage collection, and selected as the destination block when the original block (block from which data are moved) corresponds to the LBA range for which access frequency information is equal to or more than a threshold (or of high frequency) in the access frequency management table 62. The second GC block 72C also can be the destination block for garbage collection, and selected as the destination block when the original block corresponds to the LBA range for which access frequency information is less than the threshold (or of low frequency) in the access frequency management table 62.

When no first GC block 72B or no second GC block 72C in the first status is present, the GC manager 60 generates the first GC block 72B or the second GC block 72C in the first status, by transferring at least part of data stored in a first GC block 72B or a second GC block 72C in the second status to a free block.

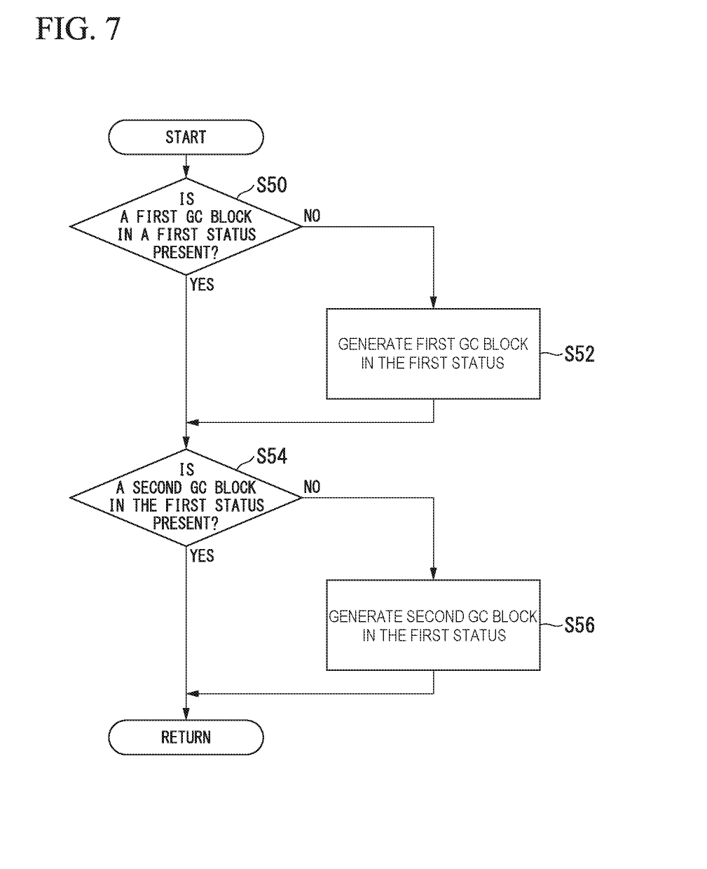

FIG. 7 is a flowchart illustrating a flow of a process executed by the GC manager 60. The process of the present flowchart is repeatedly executed by the GC manager 60 while the memory system 1 is in operation.

First, the GC manager 60 determines whether or not the first GC block 72B in the first status is present (S50). In other words, the GC manager 60 determines whether or not all first GC blocks 72B are unwritable (or, there is no remaining writable region of at least a given capacity).

When no first GC block 72B in the first status is determined to be present (No in S50), the GC manager 60 operates to generate one or more first GC blocks 72B in the first status by transferring at least part of data stored in one or more first GC blocks 72B in the second status to one or more free blocks (S52).

Next, the GC manager 60 determines whether or not the second GC block 72C in the first status is present (S54). In other words, the GC manager 60 determines whether or not all second GC blocks 72C are unwritable (or there is no remaining writable region of at least a given capacity).

When no second GC block 72C in the first status is determined to be present (No in S54), the GC manager 60 operates to generate one or more second GC blocks 72C in the first status by transferring at least part of data stored in one or more second GC blocks 72C in the second status to one or more free blocks (S56).

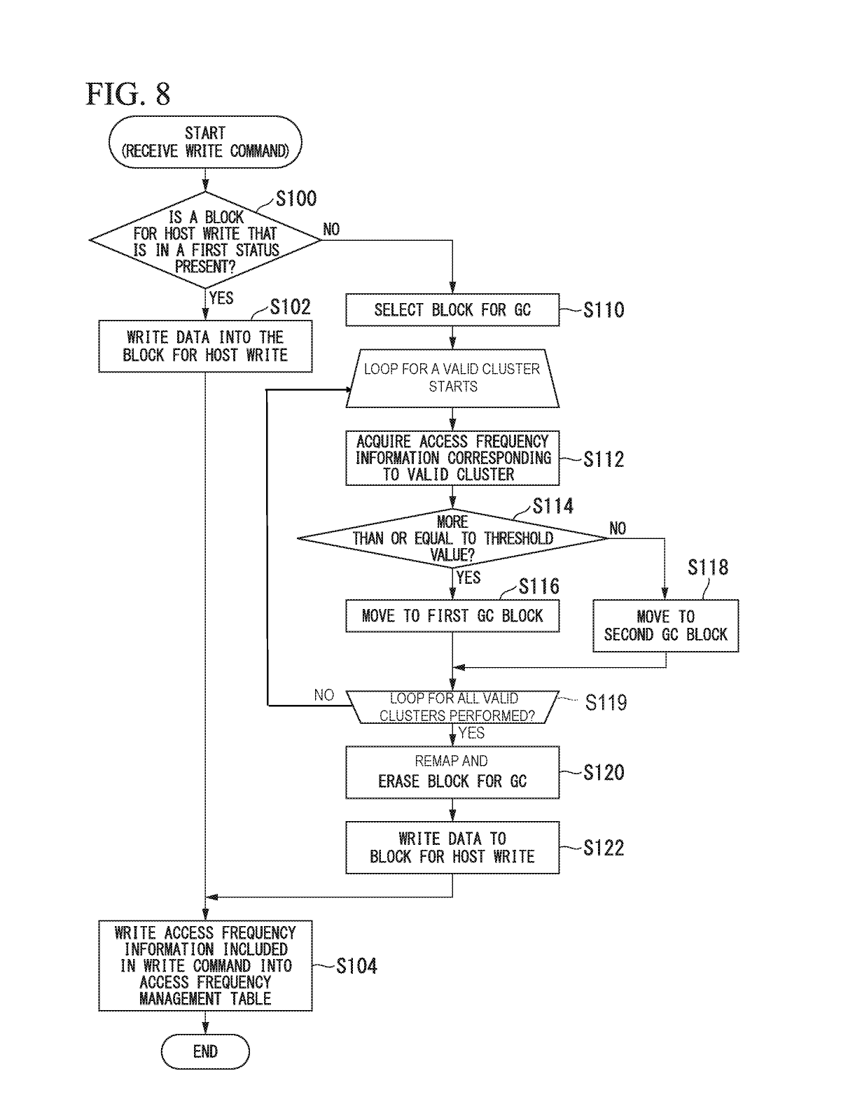

FIG. 8 is a flowchart illustrating a flow of a process executed by the memory system 1 in response to a write command. The process of the present flowchart is started when the memory system 1 receives the write command from the host 90.

First, the read/write manager 20 determines whether or not a block for host write 72A in the first status is present (S100). In S100, the read/write manager 20 may determine whether or not there is a block for host write 72A in the first status that has a sufficient number of remaining (writable) clusters to write data of a data length described in the write command.

When such a block for host write 72A in the first status is determined to be present (Yes in S100), the read/write manager 20 instructs the read/write controller 40 and writes data stored in the write buffer 24 into the block for host write 72A (S102).

Next, the GC manager 60 writes access frequency information (a write cache hit ratio) included in the write command into the access frequency management table 62 (S104). In this way, the process of the present flowchart is completed.

On the other hand, if it is determined that no block for host write 72A in the first status is present (No in S100), the GC manager 60 selects a block for garbage collection (block for GC) (S110). The block for GC is a block 72 from which data are to be moved (GC target block) when the GC manager 60 operates to perform garbage collection. While the GC manager 60 may refer to the block management table 52 and select a block 72 with the lowest valid data ratio among all blocks 72 in the second status as the block for GC, the method to select the block for GC is not limited thereto. The GC manager 60 may select a block 72 having the smallest number of erase times among blocks 72 of which valid data ratio is lower than a certain level as the GC target block, or a different condition may be applied to select the GC target block.

Next, the GC manager 60 repeats S112 to S118 for each valid cluster in the target GC block, i.e., until the determination result of S119 becomes Yes. The valid cluster is a cluster in which valid data are stored.

First, the GC manager 60 refers to the access frequency management table 62 and acquires access frequency information corresponding to the valid cluster (target valid cluster) selected in the present loop (S112). Then, the GC manager 60 determines whether or not a value of the access frequency information corresponding to the target valid cluster is equal to or greater than a threshold (S114).

When it is determined that the value of the access frequency information is equal to or greater than the threshold (Yes in S114), the GC manager 60 instructs the read/write controller 40 to move data stored in the target valid cluster to the first GC block 72B (S116).

On the other hand, when it is determined that the value of the access frequency information is less than the threshold (No in S114), the GC manager 60 instructs the read/write controller 40 to move data stored in the target valid cluster to the second GC block 72C (S118).

According to the above process, data stored in an LBA for which access frequency (write cache ratio) is high is moved to the first GC block 72B, and data stored in an LBA for which access frequency is low is moved to the second GC block 72C. As a result, distribution of the access frequency with respect to stored data is brought to be uneven among the blocks (between the first GC block 72B and the second GC block 72C). “Brought to be uneven” means brought to be unevenly distributed.

As a write command to write new data into the same LBA is likely to be received from the host 90 and the new data are written to a different region, a period of time that takes for data (old data) associated with the same LBA to become invalid is relatively short. Therefore, the valid data ratio for the first GC block 72B decreases more rapidly than that for the second GC block 72C. As the first GC block 72B tends to store fewer valid clusters and smaller amount of data need to be moved through garbage collection, the first GC block 72B is prepared as a block suitable for a target GC block. By selecting the first GC block 72 as the target GC block when garbage collection is carried out, it possible to suppress performance reduction caused in the memory system 1 due to garbage collection.

When the loop process is carried out for all valid clusters (Yes in S119), the GC manager 60 remaps the target GC block as a free block (sets an invalid flag to the LBA which corresponds to the valid cluster), and then instructs the read/write controller 40 to erase data stored in the target GC block (S120). At this time, the GC manager 60 may report a completion notification on garbage collection to the read/write manager 20. The remapped and erased target GC block is registered with the block management table 52 as a new block for host write 72A. At this time, the invalid flag is deasserted.

Next, the read/write manager 20 instructs the read/write controller 40 to write data stored in the write buffer 24 to the new block for host write 72A (S122). Next, the GC manager 60 writes access frequency information (write cache hit ratio) included in the write command into the access frequency management table 62 (S104). In this way, the process of the present flowchart is completed.

While the above-described process is operated to select one of two types of target GC blocks, respectively corresponding to high access frequency and low access frequency, the target GC blocks may be classified into three or more types based on the access frequency. In this case, a third GC block, a fourth GC block, . . . , may be prepared in advance in accordance with the access frequency.

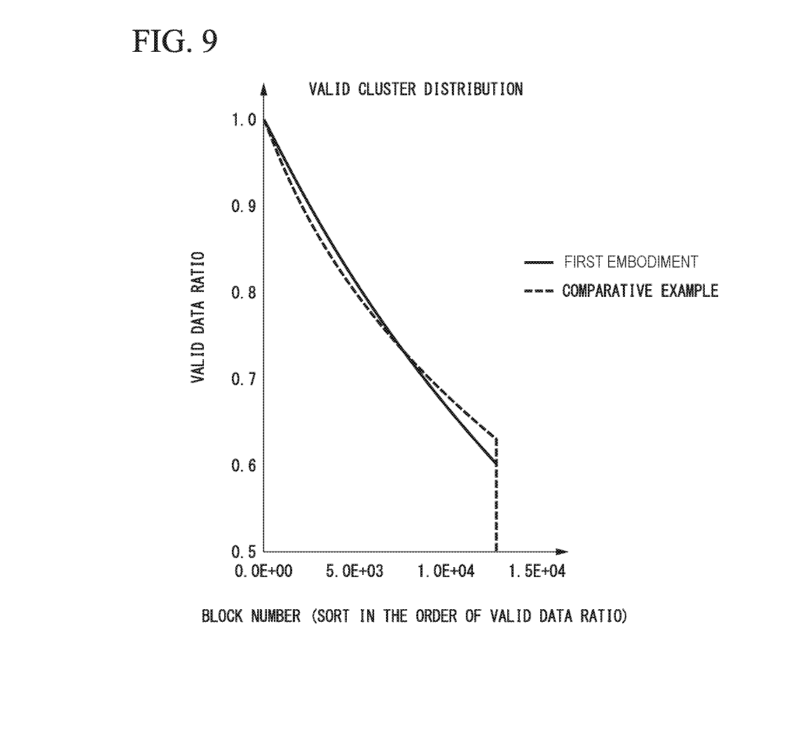

FIG. 9 illustrates simulation results of valid data ratios when the memory system 1 according to the first embodiment is operated and when a memory system according to a comparative example is operated. The solid line in FIG. 9 shows the results of supplying a predetermined number of write commands to the memory system 1 according to the first embodiment. The broken line in FIG. 9 shows the results of supplying a predetermined number of write commands to the memory system according to the comparative example. The memory system according to the comparative example moves data in a valid cluster of a target GC block to one arbitrarily-selected block 72 without performing S112-S118 in FIG. 8 during garbage collection. In FIG. 9, the horizontal axis indicates a block number sorted in the order of valid data ratio, and the vertical axis indicates a valid data ratio.

For the simulation, it is assumed that the data length for each write command is 4kB and a ratio of target write commands to the whole write commands with respect to the non-volatile memory 70 (i.e., access frequency) is changed for each 20 MB of the LBA range. For example, the ratio for 20 MB of a most frequently accessed LBA range is set to 13%, and the ratio for 20 MB of the next frequently accessed LBA range is set to 6%. Then, the generated write commands were transmitted to the memory system 1 of the present embodiment and the memory system of the comparative example in a random order. Further, for this simulation, it is assumed that the host 90 includes the cache memory 92 and the write cache hit ratio is provided to the memory system 1 according to the present embodiment.

As a result, as shown in FIG. 9, the memory system 1 according to the present embodiment shows a tendency that the valid data ratio becomes more uneven among blocks, compared to the memory system according to the comparative example. Moreover, when calculating a WAF (Write Amplification Factor, which is a value obtained by dividing an amount of data written to the non-volatile memory 70 by an amount of data instructed to be written by the write command), obtained such that, depending on the number of commands, a WAF for the present embodiment is improved to 2.51 relative to 2.72 for the comparative example, and to 2.01 relative to 2.12 for the comparative example.

The memory system 1 according to the first embodiment includes a non-volatile memory 70 having a plurality of blocks 72, each of which is a unit of erasure; and a memory control device 5 (controller) which performs control of writing data into the non-volatile memory 70 based on a write command received from a host 90 and control of erasing data for each of the blocks 72. Such a memory system 1 can cause the access frequency to be more uneven among the blocks 72 by determining the destination GC block based on the access frequency with respect to the LBA corresponding to the data to be moved when garbage collection is carried out, moving valid data stored in at least one block 72 to different destination GC blocks, and erasing the data stored in the at least one block 72. As a result, the memory system 1 can reduce the amount of data moved during the garbage collection and suppress decrease in the performance of the memory system 1 caused by carrying out the garbage collection.

Moreover, according to the memory system 1 of the first embodiment, when the first GC block 72B or the second GC block 72C is brought to a second status, which is an unwritable status, the GC manager 60 of the memory control device 5 performs garbage collection to generate the first GC block 72B or the second GC block 72C in the first status, which is a writable status, in order to continuously perform the above-described operation.

Furthermore, the memory system 1 according to the first embodiment acquires information on access frequency, such as a write cache hit ratio, etc., from the host 90, so as to prevent an internal processing load from increasing.

### Second Embodiment

While information on access frequency, such as a write cache hit ratio, etc., is acquired from the host 90 in the first embodiment, the memory system 1 according to the second embodiment generates the information on access frequency by itself and uses the generated information to determine the destination block to which data are to be moved.

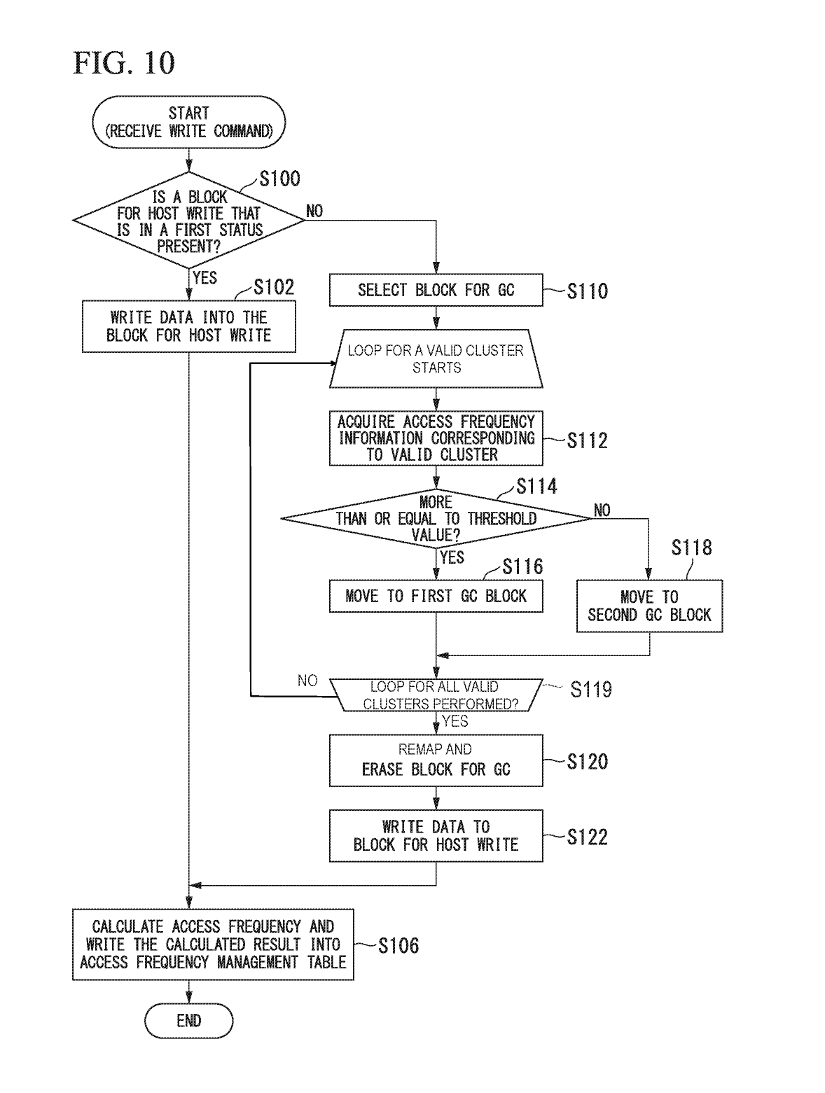

FIG. 10 is a flowchart illustrating a flow of a process executed by the memory system 1 according to the second embodiment. The process in FIG. 10 is started when the memory system 1 receives a write command from the host 90. The process illustrated in FIG. 10 is different from that illustrated in FIG. 8 in that S106 is executed instead of S104. Therefore, only the difference will be described.

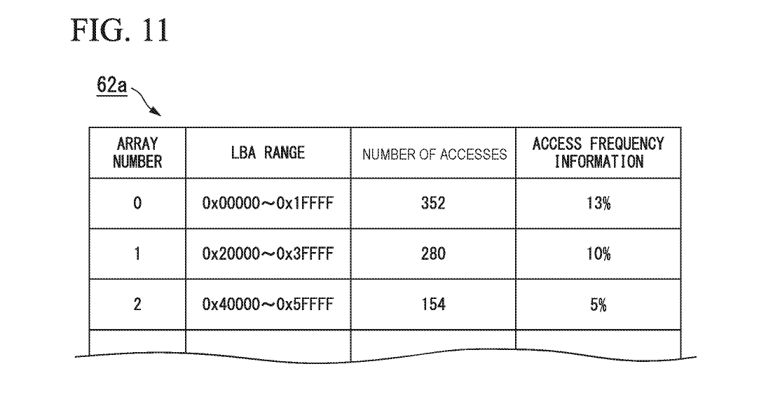

After S102 or S122, the GC manager 60 calculates the access frequency and writes the calculated result into the access frequency management table 62 (S106). FIG. 11 illustrates an access frequency management table 62a according to the second embodiment. In the access frequency management table 62a, the number of accesses and access frequency information may be associated with each LBA range in each entry. When the write command is received, the GC manager 60 causes the number of accesses with respect to an LBA range designated by the write command to be increased by 1. As the data length designated by the write command becomes longer, the GC manager 60 may increase the number of accesses with respect to the LBA range. Then, the GC manager 60 divides the number of accesses with respect to the LBA range by the total of the number of accesses with respect to all LBA ranges registered in the access frequency management table 62a and obtains the access frequency information.

The memory system 1 according to the second embodiment can reduce the amount of data moved during the garbage collection and suppress decrease in the performance of the memory system 1 caused by carrying out the garbage collection, similarly to the first embodiment. Further, according to the second embodiment, the access frequencies can be made uneven among the blocks 72 even when the host 90 does not provide access frequency information such as the write cache hit ratio, etc.

### Third Embodiment

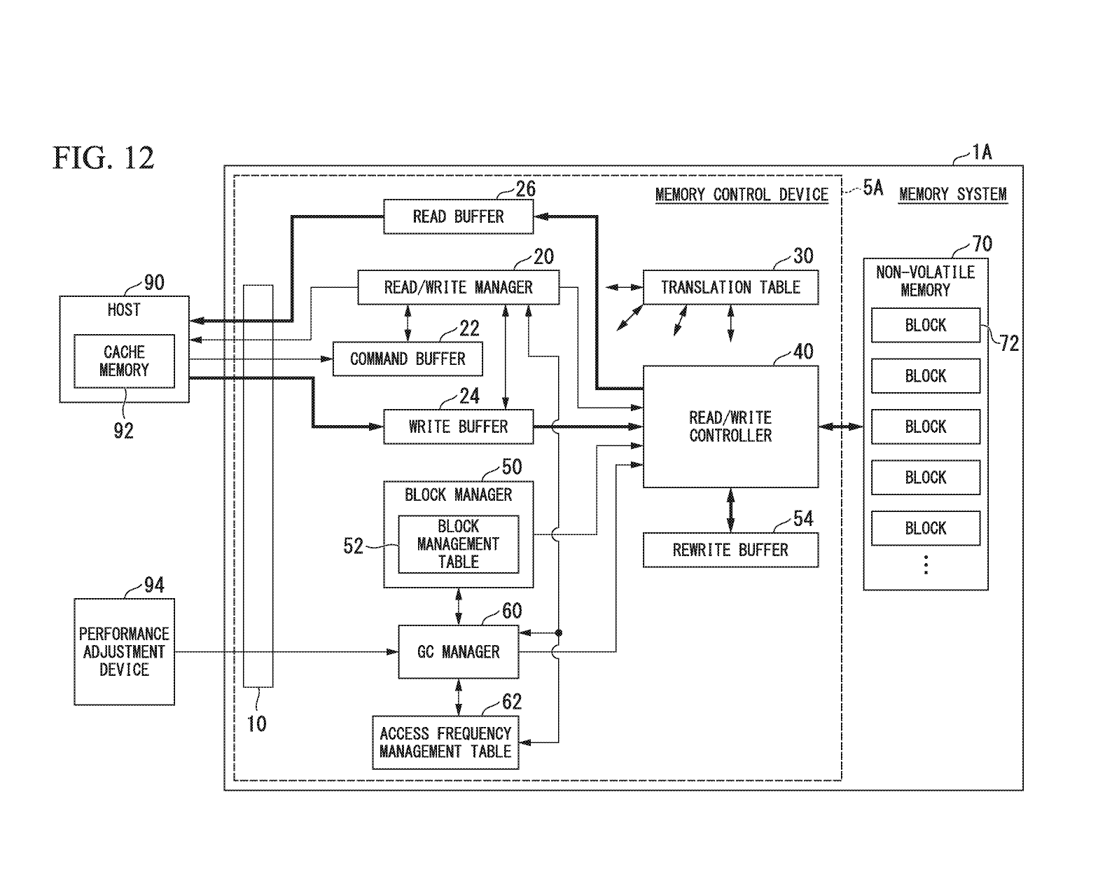

FIG. 12 illustrates a memory system 1A and a memory control device 5A according to the third embodiment. As shown in FIG. 12, the memory system 1A according to the third embodiment is connected to a performance adjustment device 94 (external device). The performance adjustment device 94 may be the same device as the host 90, or a difference device from the host 90. In accordance with operations of a user, the performance adjustment device 94 determines a threshold value that is used by the GC manager 60 and transmits information on the threshold value to the memory system 1A.

According to the third embodiment, when garbage collection is performed, the GC manager 60 determines whether data in a valid cluster are moved to the first GC block 72B or the second GC block 72C based on the using the threshold value received from the performance adjustment device 94 (See S114-S118 in FIG. 10). The threshold value is stored in a table, etc., (not shown) that is managed by the GC manager 60.

The memory system 1A according to the third embodiment enables the user to arbitrarily determine the threshold value used to determine the destination block to which the data in the valid cluster are to be moved when performing garbage collection.

### Further Embodiments

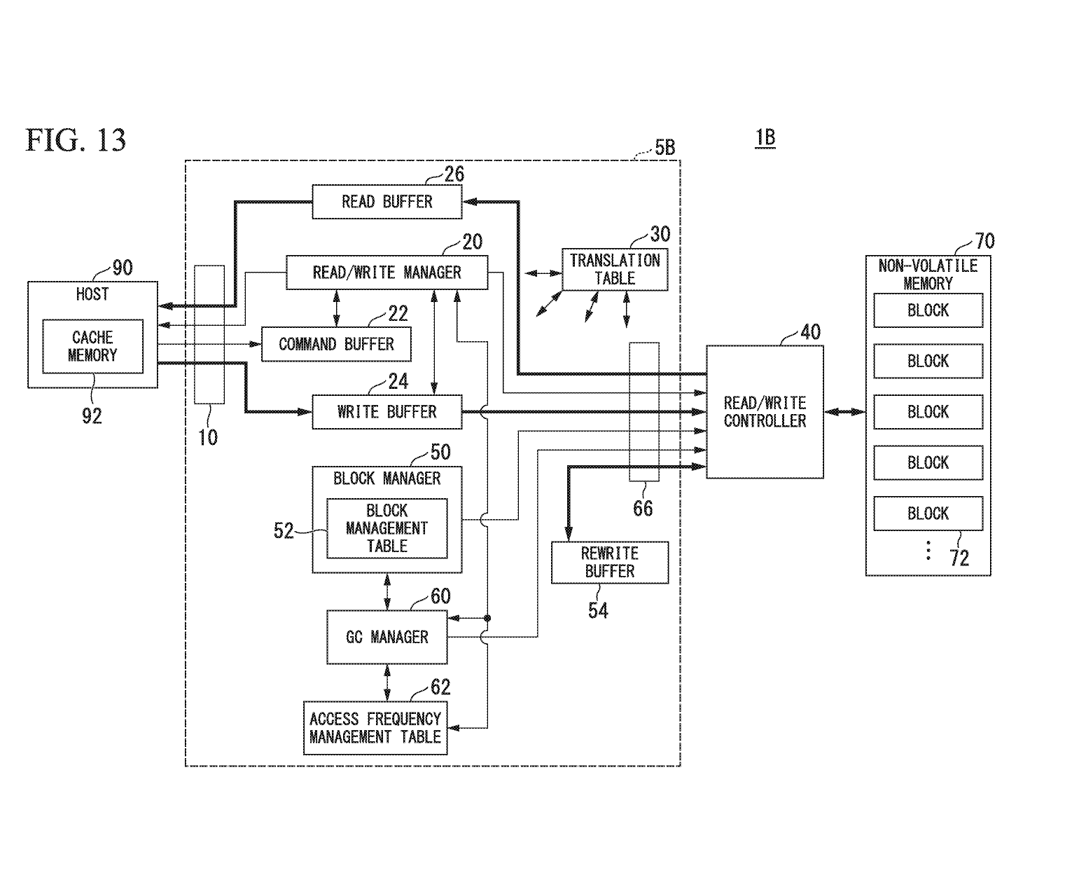

In the embodiments described above, the configuration of the memory control device may be modified as shown below. FIG. 13 illustrates a memory system 1B according to a first modification example. In the memory system 1B, a memory control device 5B is configured as a device separate from the read/write controller 40 and connected to the read/write controller 40 via an interface 66. Functions of each element of the memory control device 5B are the same as functions of each element described in the first to third embodiments. The memory control device 5B receives a command from the host 90, performs the same processes as the processes described in the first to third embodiments, and outputs instructions to the read/write controller 40 or transmits/receives data to/from the read/write controller 40 via the interface 66.

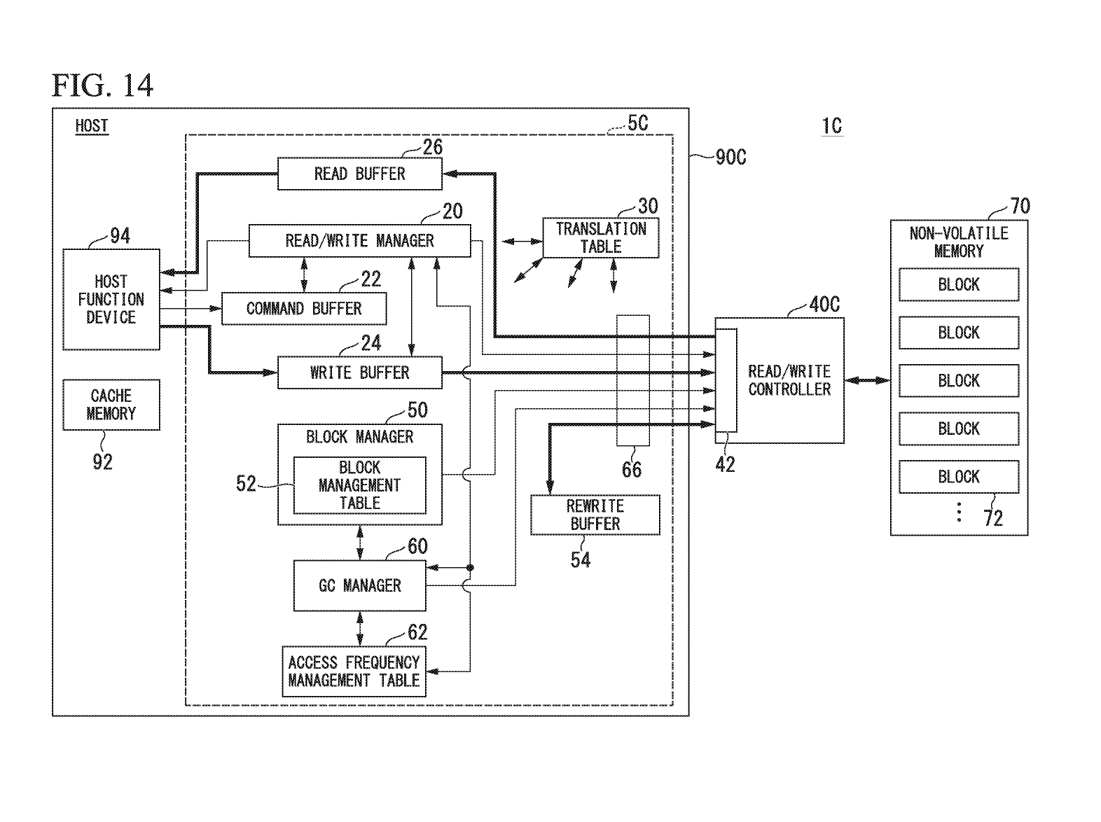

Moreover, the memory control device may be included in the host 90. FIG. 14 illustrates a memory system 1C according to a second modification example. A host 90C according to the second modification example includes a host function device 94 which has the same functions as the host 90 described in the first to third embodiments. A memory control device 5C receives a command from the host function device 94 via a communications network within the host 90C, performs the same processes as the processes described in the first to third embodiments, and outputs instructions to the read/write controller 40 or transmits/receives data to/from the read/write controller 40 via the interface 42 of the read/write controller 40C and the interface 66.

According to at least one embodiment described in the foregoing, a memory system includes a non-volatile memory 70 including a plurality of blocks 72, each of the blocks 72 being an erasure unit, and a memory control device 5 (controller) which performs control of writing data into the non-volatile memory 70 based on a write command received from a host 90 and control of erasing data from each of the block 72. Further, during garbage collection, valid data stored in at least one of the blocks 72 are moved to a different one of the blocks 72 and data stored in the at least one of the blocks 72 are erased, and the different one of the blocks 72 is selected as a destination to which the data are to be moved based on information on access frequency with respect to the corresponding LBA of the data to be moved so as to make the access frequency uneven among the blocks 72. As a result, it is possible to reduce the amount of data moved during the garbage collection and suppress decrease in the performance of the memory system 1 caused by carrying out the garbage collection.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system, comprising:
a non-volatile memory including a plurality of memory blocks, a memory block being a unit of data erasing; and
a memory controller configured to control data writing into the non-volatile memory, data erasing from the non-volatile memory, and garbage collection of the non-volatile memory, wherein
when the garbage collection is carried out with respect to a target memory block, the memory controller selects a memory block to which valid data stored in the target memory block are to be transferred, based on a value indicating access frequency to a logical address range mapped to the valid data.

2. The memory system according to claim 1, wherein
when the garbage collection is carried out with respect to the target memory block, the memory controller transfers valid data mapped from a frequently-accessed logical address range to a first memory block, and valid data mapped from a less-frequently-accessed logical address range to a second memory block.

3. The memory system according to claim 2, wherein
the memory controller determines the logical address range mapped to the valid data as the frequently-accessed logical address range when the value thereof is greater than a threshold value, and as the less-frequently-accessed logical address range when the value thereof is smaller than the threshold value.

4. The memory system according to claim 3, wherein
the memory controller receives the threshold value from a host, and maintains the received threshold value.

5. The memory system according to claim 2, wherein
when the memory controller determines that there is no memory block for storing valid data mapped from the frequently-accessed logical address range, the memory controller prepares the first memory block before the garbage collection is carried out, and
when the memory controller determines that there is no memory block for storing valid data mapped from the less-frequently-accessed logical address range, the memory controller prepares the second memory block before the garbage collection is carried out.

6. The memory system according to claim 1, wherein
the memory controller carries out the garbage collection, when the memory controller determines that there is no memory block for storing data that are requested to be written by a write command from a host.

7. The memory system according to claim 1, wherein
the memory controller receives the value indicating access frequency from a host along with a write command to write the valid data, and maintains the received value.

8. The memory system according to claim 7, wherein
the value indicating access frequency corresponds to a cache hit ratio with respect to a logical address within the logical address range in the host.

9. The memory system according to claim 1, wherein
the memory controller is further configured to calculate the value based on a number of times data mapped from the logical address range are accessed.

10. A memory control device, comprising:
a host interface connectable to a host;
a memory interface connectable to a non-volatile memory;
a controller configured to control via the memory interface, data writing into the non-volatile memory, data erasing from the non-volatile memory, and garbage collection of the non-volatile memory, wherein
when the garbage collection is carried out with respect to a target memory block, the controller selects a memory block to which valid data stored in the target memory block are to be transferred based on a value indicating access frequency to a logical address range mapped to the valid data.

11. The memory control device according to claim 10, wherein
when the garbage collection is carried out with respect to the target memory block, the controller transfers valid data mapped from a frequently-accessed logical address range to a first memory block, and valid data mapped from a less-frequently-accessed logical address range to a second memory block.

12. The memory control device according to claim 11, wherein
the controller determines the logical address range mapped to the valid data as the frequently-accessed logical address range when the value thereof is greater than a threshold value, and as the less-frequently-accessed logical address range when the value thereof is smaller than the threshold value.

13. The memory control device according to claim 12, wherein
the controller receives the threshold value from a host via the host interface, and maintains the received threshold value.

14. The memory control device according to claim 11, wherein
when the controller determines that there is no memory block for storing valid data mapped from the frequently-accessed logical address range, the controller prepares the first memory block before the garbage collection is carried out, and
when the controller determines that there is no memory block for storing valid data mapped from the less-frequently-accessed logical address range, the controller prepares the second memory block before the garbage collection is carried out.

15. The memory control device according to claim 10, wherein
the controller carries out the garbage collection, when the controller determines that there is no memory block for storing data that are requested to be written by a write command from the host via the host interface.

16. The memory control device according to claim 10, wherein
the controller receives via the host interface the value from the host along with a write command to write the valid data, and operates to maintain the received value.

17. The memory control device according to claim 10, wherein
the controller is further configured to calculate the value based on a number of times data mapped from the logical address range are accessed.

18. A method for controlling a non-volatile memory, comprising:
selecting a target memory block of the non-volatile memory from which valid data stored therein are to be transferred;
selecting a destination memory block of the non-volatile memory to which the valid data are to be transferred based on a value indicating access frequency to a logical address range mapped to the valid data; and
transferring the valid data from the target memory block to the destination memory block.

19. The method according to claim 18, wherein
a first memory block is selected as the destination memory block, when the logical address range is determined to be a frequently-accessed logical address range, and
a second memory block is selected as the destination memory block, when the logical address range is determined to be a less-frequently-accessed logical address range.

20. The method according to claim 19, further comprising:
determining whether or not a logical address range is the frequently-accessed logical address range or the less-frequently-accessed logical address range based on a cache hit ratio of the logical address range.
